(19) United States
(12) Patent Application Publication
(10) Pub. No.: US 2009/0107236 A1
(43) Pub. Date: Apr. 30, 2009

(54) STRAIN SENSOR PACKAGE WITH CONNECTING PINS IN LID

(76) Inventors: Raymond David Lohr, Buckinghamshire (GB); Arthur John Leigh, Oxfordshire (GB); Paul Edward Vickery, Northants (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/346,298

(22) Filed: Dec. 30, 2008

(51) Int. Cl. G01D 11/24; B23P 11/00

(52) U.S. Cl. 73/431; 29/428

(57) ABSTRACT

An apparatus 1 for packaging a sensor device comprises a main body 2 having an internal chamber 4 with a base 2b on which, in use, is mounted the sensor so as to couple the sensor to the strain field in an article to which the packaging is attached by means of said base. A lid 3 is separately formed from and is formed of a different material to said base 2b and is sealable to the main body 2 in order to seal close said internal aperture 4. The lid 3 includes contact pins 8, 9 which extend therethrough from one side to the other. A first end 8a, 8b of each said pin 8, 9 extends into said chamber 4 when the lid 3 is positioned on the body 2 for connection to said sensor and a second end 8b, 9b of each said pin 8, 9 extends away from the package when the lid 3 is positioned on the body 2 for connection to a rotary coupler.

### BACKGROUND OF THE INVENTION

1. Field of the Invention

The present invention relates to packages for housing strain sensors such as SAW based strain sensors by means of which the sensor is coupled to the strain field in an article whose strain is to be measured.

2. The Prior Art

It is well known in the art to mount a sensor on the surface of a device to measure the strain therein, by means of which other information can then be calculated, such as, for example the torque being transmitted by the article. Due to the vulnerability of a sensor to damage when mounted directly on an article such as a rotating shaft, it is further known to house the sensor in a package which is, in turn, bonded to a surface of the article whose strain is to be measured. The sensor is attached to an inner surface of a base of the package and the package secured to the article by the outer surface of the base in such a way that the strain field in the article is transmitted through the base to the sensor. In this way, the sensor is protected against damage during installation and use whilst still providing effective measurement of the strain in the article.

In a typical application, the sensor package is secured to the outer surface of a rotating shaft and the data from the sensor is communicated to a receiver which is located on a stationary component by means of a rotary coupler. In order to communicate data from the sensor to the rotary coupler, a pair of connecting pins are typically provided in the package which penetrate from the outside to the inside thereof. The inside ends of the pins are then connected to respective contacts on the sensor and the outside ends of the pins are connected to contacts on the rotary coupler. Conventionally, the pins extend through a side wall of the package. This is because it is advantageous that once the sensor has been installed in the package and the connecting wires attached between the pins and the contacts on the sensor, there is no movement between the pins and the sensor. Any such movement would change the stress applied to the sensor by the wires attached thereto which would introduce errors into the readings from the sensor in use. It has in the past been suggested to pass the pins through the bottom of the package on which the sensor is attached but this impacts on the strain field transmitted to the sensor and hence again introduces errors.

It has recently been found that certain materials, such as Precipitation Hardening Martensitic Stainless Steels, have advantageous properties in terms of providing a high yield strength suitable for the elastic transfer of strain for the transmission of the strain field of the article being analysed to the sensor mounted within in the package, and it has therefore been proposed to use such material to form the package. Whilst such material does, indeed, afford these advantages, it has the drawback that it gives rise to issues with hermetic sealing of the pins to the package. Glass frit has been proposed to be used for this purpose but in practice the results have been found not be produce acceptable performance.

### SUMMARY OF THE INVENTION

According to the present invention there is provided an apparatus for packaging a sensor device comprising a main body having an internal chamber with a base on which, in use, is mounted the sensor so as to couple the sensor to the strain field in an article to which the packaging is attached by means of said base, and a lid which is separately formed from and is formed of a material having different proportions to the material of said base, the lid being sealable to the main body in order to seal close said internal aperture, the lid including contact pins which extend therethrough from one side to the other, a first end of each said pins extending into said chamber when the lid is positioned on the body for connection to said sensor and a second end of each said pin extending from away from the package when the lid is positioned on the body for connection to a rotary coupler.

A package in accordance with the invention has the advantage that, by mounting the pins in the lid rather than in the main body, as is the convention, the main body can be formed of a material which has advantageous elastic properties for the communication of the strain from the article to the sensor mounted within the packaging, while the lid can be formed of a material which facilitates sealing of the pins, thereby overcoming the problems of the prior art approaches. In addition the main body becomes axi-symmetric, thereby facilitating its manufacture, for example by being wholly turnable on a lathe. Furthermore, by positioning the pins on the lid, they do not present any sort of obstacle for accessing the edge of the base for securing the package to the article, for example by welding.

The different material properties may be achieved by forming the lid from a completely different material to that from which the base is formed. Alternatively, however, the two parts may be formed of the same material but formed in a different way—for example, in a different phase, subject to different finishing/hardening operations and the like. For example, the lid may be formed of AISI 304L annealed to facilitate glass fritting, whereas the base may be formed of AISI 304L in a ½ or ¾ hard state providing a high yield strength suitable for the elastic transfer of strain.

Preferably, the packaging further includes a contact plate located within the internal chamber having a pair of connected contact pads for each pin in the lid, one of each said pair of connected contact pads being electrically coupled, in use, by connecting means such as wire to a contact pad on the sensor and the other of each of said pair of connected contact pads being electrically coupled, in use, by connecting means to the first end of one of said pins. In this way, the connection means which extend from the pins are not directly connected to the sensor and hence the risk of stress being applied to the sensor upon movement of the connector means, for example upon positioning of the lid, is eliminated. Instead, the connections from the sensor lead to the contact plate which is fixed within the chamber and hence, once the connection means have been connected between the contact plate and the contacts on the sensor, relative movement which might give rise to stressing of the sensor contacts can be eliminated.

Each pin is preferably shaped so that the second end extends perpendicularly to the plane of the lid whilst the pin is bent through 90 degrees after passing through the lid so that the first end extends parallel to the plane of the lid. This has advantages in terms of space and also makes connection to the first ends easier.

The pins may be directly mounted in the lid but in an alternative embodiment are mounted in a carrier which is separately formed from and mountable in an opening formed in the lid. This has the advantage that the lid can be moved aside whilst connection of the pins to the contacts of the contact plate is effected, making that operation easier. In particular, the carrier may be formed with a radially extending flange on one end which extends to a diameter larger than the opening formed in the lid. The remainder of the carrier is sized so as to be able to fit through the opening and the flange then forms a seat against the surface of the lid.

The opening may be a simply circular opening so that the carrier is pushed through the lid from one side. However, the opening may also extend to a side of the lid so that the carrier is inserted sideways into the opening. The opening may, in particular, taper outwardly towards the side so as to facilitate positioning of the carrier therein. A locking plate may then be engageable into the opening from said side behind the carrier so as to secure it in place. The locking plate may, for example, be of thickness equal to the thickness of the lid and include side recesses so that locking plate engages in recesses formed in both surfaces of the lid around the opening.

Preferably, the contact means which extend from each pin to the contact plate is formed by a first generally flat part which, in use, connects to the first end of the associated pin and a second curved part which, in particular is curved into a loop, the end of which loop fastens to the contact plate. This has the advantage that each said contact means can easily be bent by opening the loop to facilitate attachment of the contact means to the pin.

In a still further embodiment, the pin carrier may be formed with legs, in particular four spread legs which, when the carrier is secured to the lid and the lid is fastened to the main body, extend towards the base of the chamber and engage there against to support the pins in position. Instead of legs, the pin carrier may be formed with a downwardly extending skirt which again engages with the base of the chamber to support the pins in place.

The present invention further provides a method of packaging a sensor comprising the steps of providing an apparatus according to the invention, mounting the sensor to the base of the main body, connecting signal contacts on the sensor to respective contact pins, positioning the lid on the main body so as to close the chamber with the pins protruding from the top of the lid and securing the lid to the main body.

Preferably, assembly of the packaging is facilitated using a carrier plate which supports the pin carrier over the body whilst connections are made to the pins. In particular, the carrier plate preferably has an opening therein for supporting the pin carrier and has a V-shaped recess in a side thereof which extends to said opening, the carrier being positioned over the body and the pin carrier sat in the opening in the carrier plate with the first end of each pin extending underneath the V-shaped recess so as to be exposed by said recess. The connections between the first end of each pin and the signal contacts on the sensor are then made, the lid then positioned on the carrier plate with the pin carrier engaging in the opening formed in the lid, the lid secured to the pin carrier, the carrier plate removed from beneath the lid and pin carrier by withdrawing the carrier plate sideways so that the pin carrier passes along the V-shaped recess, and finally the lid secured to the body.

The lid is hermetically sealed to the pin carrier and also to the body, in particular by laser welding. In the instance where the apparatus includes a contact plate, the method preferably comprising the further steps of securing the contact plate to the base of the main body, completing connections between the contact plate and the sensor, completing connections between the contact plate and the pins and then closing the main body with the lid.

### BRIEF DESCRIPTION OF THE DRAWINGS

In order that the invention may be well understood, there will now be described some embodiments thereof, given by way of example, reference being made to the accompanying drawings, in which:

FIG. 1A is a cross-sectional view taken along the line A-A from FIG. 1B, illustrating a sensor package according to a first embodiment of the invention.

FIG. 1B is a rear side elevational view thereof.

FIG. 1C is a perspective view thereof.

FIG. 1D is a top plan view thereof.

FIG. 1E is an exploded view thereof.

FIG. 2A is a perspective view illustrating an assembly method of the sensor package according to the first embodiment.

FIG. 2B is a cross-sectional view thereof.

FIG. 2C is an exploded view thereof.

FIG. 2D is a further perspective view thereof.

FIG. 2E is a further cross-sectional view thereof.

FIG. 2F is a further exploded view thereof.

FIG. 3A is a perspective view of a sensor package according to a second embodiment of the invention.

FIG. 3B is a cross-sectional view thereof.

FIG. 3C is an exploded view thereof.

FIG. 3D is a side elevational view thereof with the lid open.

FIG. 3E is a perspective view thereof with the lid open.

FIG. 4A is a perspective view of a sensor package according to a third embodiment of the invention.

FIG. 4B is a cross-sectional view thereof.

FIG. 4C is an exploded view thereof.

FIG. 5A is a perspective view of a sensor package according to a fourth embodiment according to the invention.

FIG. 5B is a cross-sectional view thereof.

FIG. 5C is an exploded view thereof.

### DETAILED DESCRIPTION OF THE PREFERRED EMBODIMENTS

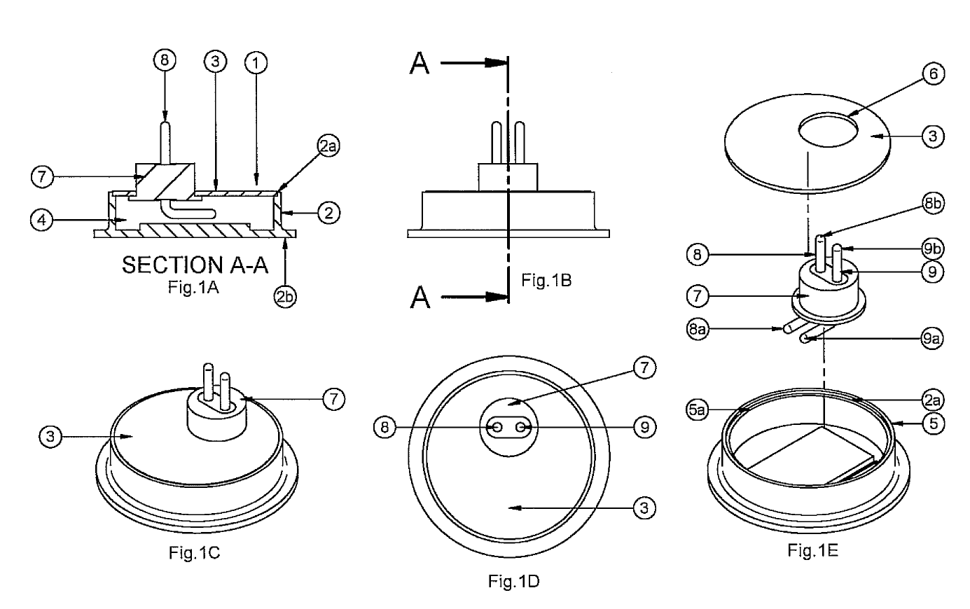

Referring first to FIGS. 1A to 1E, there is shown a sensor package generally indicated by 1 according to a first embodiment of the invention. The package 1 is formed by a cylindrical body 2 having an open upper end 2a and a base 2b, and a lid 3, which is separately formed from the body 2 and engages with the upper end 2a to close the body 2 with a cylindrical chamber 4 formed therebetween. The upper end 2a of the body has a recess 5 formed on its inner cylindrical surface extending away from the upper end, and the lid 3 is sized to fit into the recess so that it is a flush fit (FIG. 1A) with the upper end 2a of the body 2 and seats on a lip 5a formed by the base of the recess 5 as shown in FIG. 1E.

The base is formed of a suitable material, such as Precipitation Hardening Martensitic Stainless Steel, for example 17-4PH or 17-7PH, which ensures good coupling of the package to the stress field in a article such as a rotating shaft (not shown) to which the package is attached in order to monitor the strain therein. In a well known manner which will not be described in greater detail, a strain sensor such as a SAW based strain sensor is fastened to the inner surface of the base 2b.

The lid 3 has an opening 6 formed therein in which is engageable a pin carrier 7 as shown best in FIG. 1E. The pin carrier 7 has a pair of pins 8, 9 which serve to provide an electrical contact between the sensor mounted in the package and an external signal coupling system such as a rotary coupler (not shown). A first end 8a, 9a of the pins 8, 9 which extend into the chamber 4 are bent through 90 degrees so as to extend parallel to the plane of the lid whereas a second end 8b, 9b of the pins 8, 9 extend perpendicularly from the top of the lid 3. The pin carrier 7 may be secured in place in the opening 6 in a well known manner such as by welding or by using glass-frit, the material of the lid being chosen to best suit the chosen bonding system.

In use, then, once the sensor has been mounted on the base 2b, wires may be connected between contact pads on the sensor and the inner first ends 8a, 9a of the pins 8, 9 so as to enable electrical connection to be made from the outer second ends 8b, 9b of the pins to the sensor. The pin carrier 7 is then secured to the lid and the lid then secured in place in the upper end 2a of the body 2. The package may then be located for use and secured to the required surface and wires or the like run from the exposed outer second ends 8b, 9b to a signal coupler such as a rotary coupler.

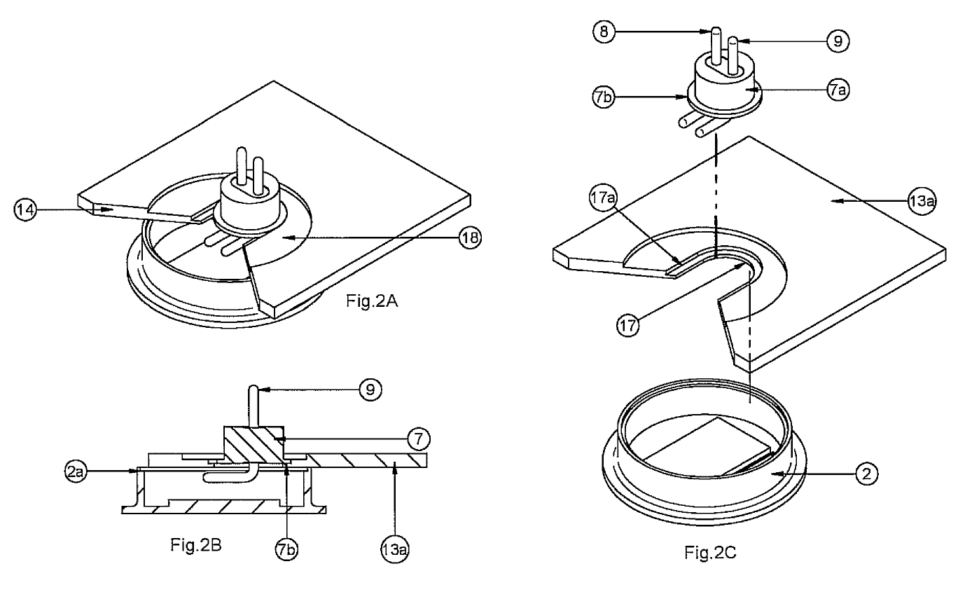

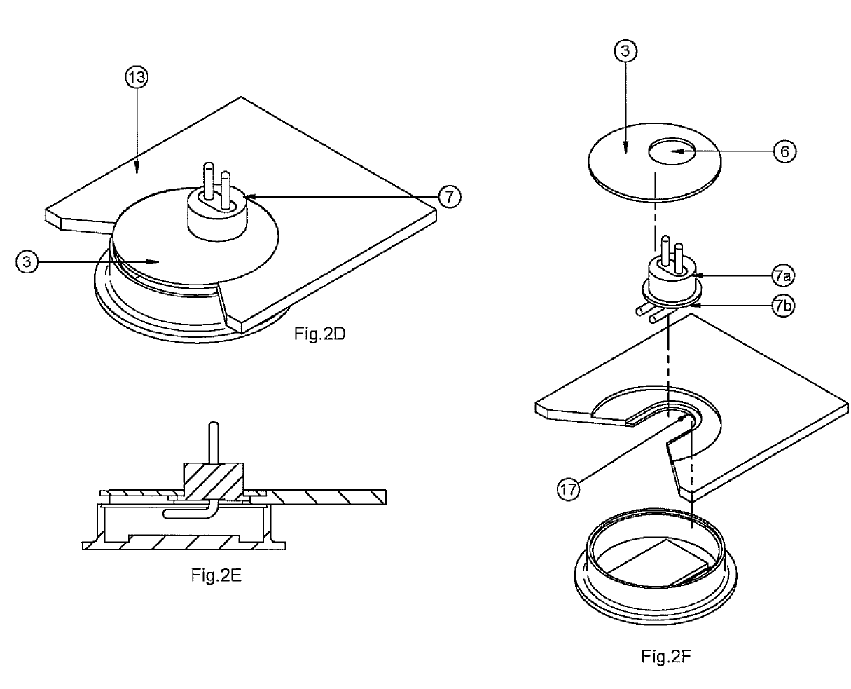

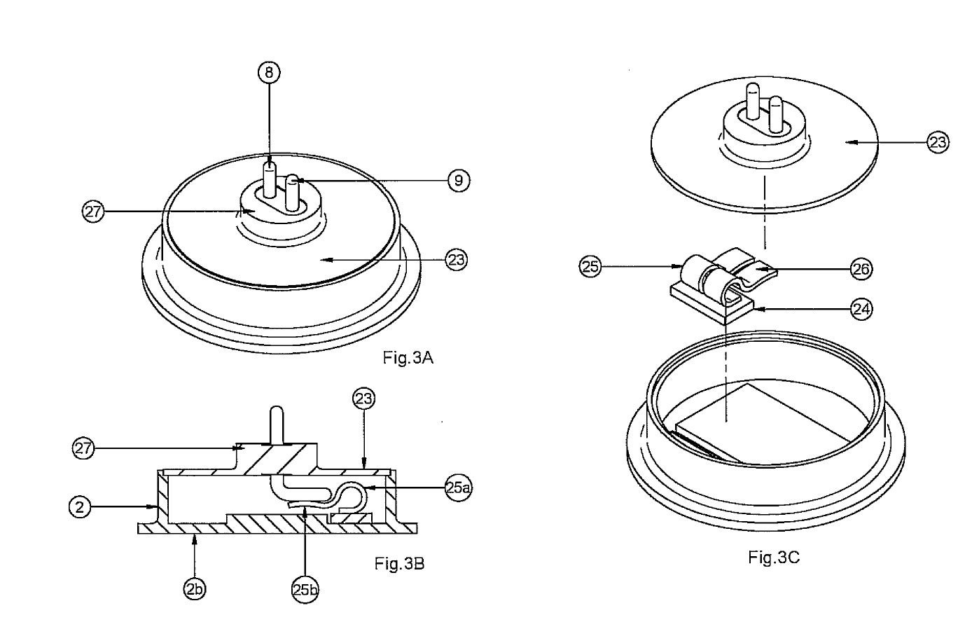

FIGS. 2A to 2F show the various steps involved in assembling the sensor package according to the first embodiment of the invention. Central to the assembly method is a carrier plate 13 which is used to support the pin carrier 7 whilst the wires are connected between the pins 8, 9 and the sensor and also whilst the lid is secured to the pin carrier 7. The carrier plate 13 has an opening 17 formed therein for receiving the carrier 7, the edge of which has a lip 17a which reduces the diameter of the opening 17 to a size which is slightly smaller than the outer diameter of the bottom flange 7b of the carrier 7 such that the carrier 7 sits on top of the carrier plate 13 with the flange 7b seated on the lip 17a and the pins 8, 9 extending into the chamber 4. In this way, the carrier plate 13 supports the pin carrier 7 in place above the body 2. A V-shaped side opening 14 is formed in the carrier plate 13 extending to the opening 17, and, as shown in FIG. 2F, pin carrier 7 is oriented with respect to the carrier plate 13 so that the first ends 8a, 9a of the pins 8, 9 extend beneath the side opening 14 and are therefore easily accessible when the pin carrier 7 is supported on the carrier plate 13. This facilitates the making of the connections between the first ends 8a, 9a of the pins 8, 9 and the sensor. The opening 17 also allows the carrier plate 13 to be slid out from underneath the pin carrier 7 when assembly has been completed.

A circular recess 18 is also formed in the top of the carrier plate 13 around the opening 17, which recess 18 is sized complement to the outer diameter of the lid 3 so that the lid 3 can be seated over the pin carrier 7, on the carrier plate 13 with the pin carrier 7 extending through the hole 6 in the lid 3, the lid 3 sitting in the recess 18 with its top surface flush with the top of the carrier plate 3 as shown in FIG. 2E. Since the locating of the lid will cover the exposed first ends 8a, 9a of the pins 8, 9, this is done after the connections have been made between the pins 8, 9 and the sensor, and, after the lid has been positioned, the pin carrier 7 is then secured to the lid 3 preferably by laser welding.

Finally, the carrier plate 13 is removed from beneath the lid and pin carrier and the lid 3 seated directly on the body where it is welded in position to effect a hermetic seal with the body.

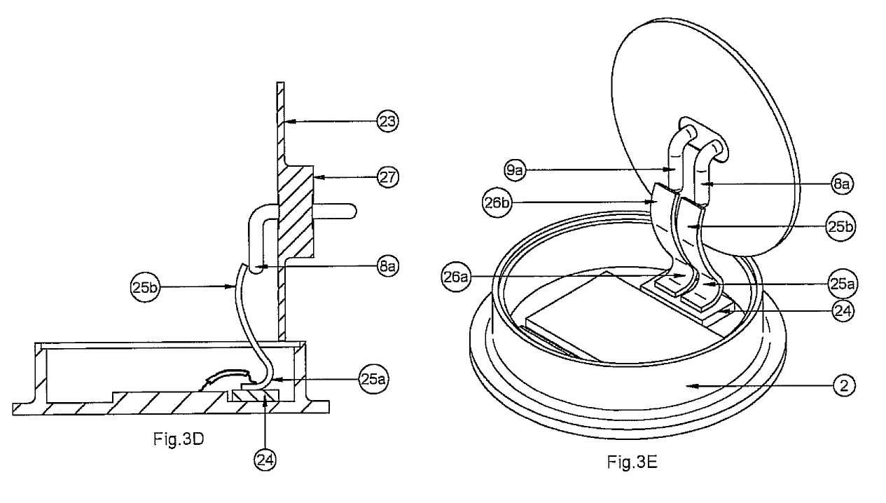

Referring next to FIGS. 3A to 3E, there is shown a further embodiment of the invention which is applicable for use with either of the embodiment described above as well as those described hereinafter. In this embodiment, the lid 23 is shown as having the carrier 27 integrally formed therewith although it will be understood that this is not essential and may be separately formed as in the first embodiment. As with the first embodiment, the lid is sized to engage in the open end 2a of the body 2 and to sit on the recess 5 formed thereon which formed the base of a step so that the lid 23 sits flush with the top of the body 2 as shown in FIG. 3B. In difference to the earlier embodiments, the base 2b has mounted thereon an intermediate contact carrier or contact plate 24 which has a pair of contacts for making an electrical connection to signal contacts of a sensor mounted in the packaging and a pair of contact arms 25, 26, each of which contacts the first end 8a, 9a of one of the pins 8, 9 as shown in FIG. 3B. Each contact arm 25, 26 is electrically connected to one of the contacts on the contact carrier so as to create a contact between the associated pin 8, 9 and the sensor. Since both the contact carrier 24 and the sensor are mounted on the base, the connection therebetween can be made short since no relative movement is necessary therebetween once mounting has been completed. Accordingly, the risk of the sensor being stressed due to stress in the contact wires connected thereto is eliminated.

Each contact arm 25, 26 is formed by a looped section (1^{st} contact pad) 25a, 26a which connects to the sensor via a wire as shown in FIG. 3D. A generally flat arm section (2^{nd} contact pad) 25b, 26b connects to the associated pin 8, 9. The contact arms 25, 26 are furthermore formed of flexible material so as to enable them easily to be bent by opening up the looped section 25a, 26a without applying significant stress to the contact carrier 24 which could in turn be transmitted to the sensor. This enables the arms 25, 26 to be folded to a convenient position for securing to the pins 8, 9, for example with the lid 23 tilted up as shown in FIG. 3D and the lid then positioned in the packaging and secured in place without stressing the contact carrier or the sensor.

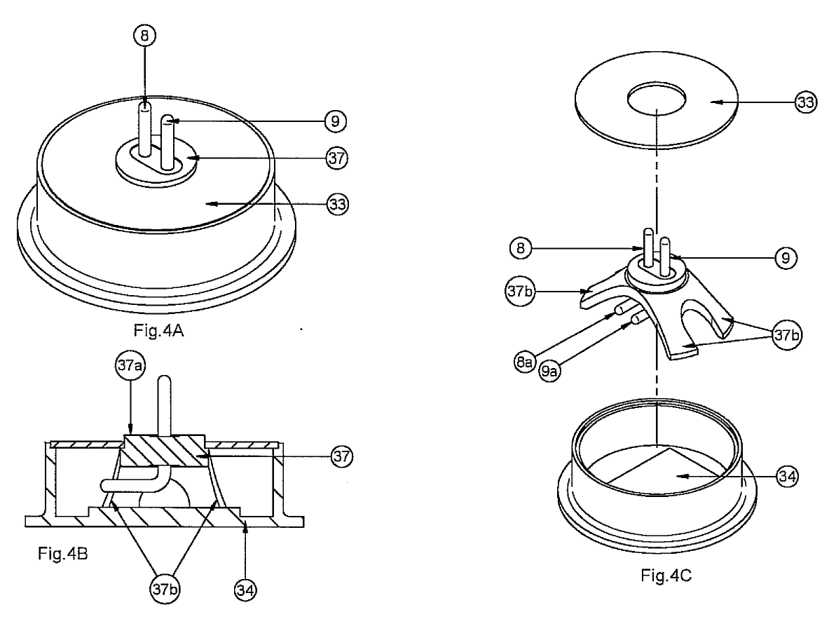

FIGS. 4A to 4C show yet another embodiment which has yet another mechanism for securing the pin carrier to the lid. In the embodiment, the pin carrier 37 is formed as a bridge member having an upper cylindrical portion 37a from which the second ends 8b, 9b of the pins 8, 9 extend and legs 37b which extend downward and outwards from the cylindrical portion 37. The pins 8, 9 extend from the bottom of the cylindrical portion 37a and turn through 90 degrees so that the first ends 8a, 9a project between two of the legs 37b as shown in FIG. 4C.

The carrier 37 is located within the chamber 4 of the package with the legs seated on a raised platform 34 formed on the base 2b. The raised platform 34 is thicker than the remainder of the base 2b so as to ensure that no stress is transmitted into the main part of the base 2b which could introduce errors into the readings taken by the sensor. With the legs 37b engaged with the platform 34, the top of the cylindrical portion 37a of the carrier 37 and the second ends 8b, 9b of the pins 8, 9 extend beyond the top edge 2a of the body 2, and a lid 33 locates over the projecting top of the cylindrical portion 37a, an opening 36 being formed in the lid in which the cylindrical portion 37a locates. The lid 33 then seats on the lip 5a of the top of the body and is secured in position. Suitable connections are, of course, made between the pins 8, 9 and the sensor prior to mounting of the carrier 37 and securing of the lid 33.

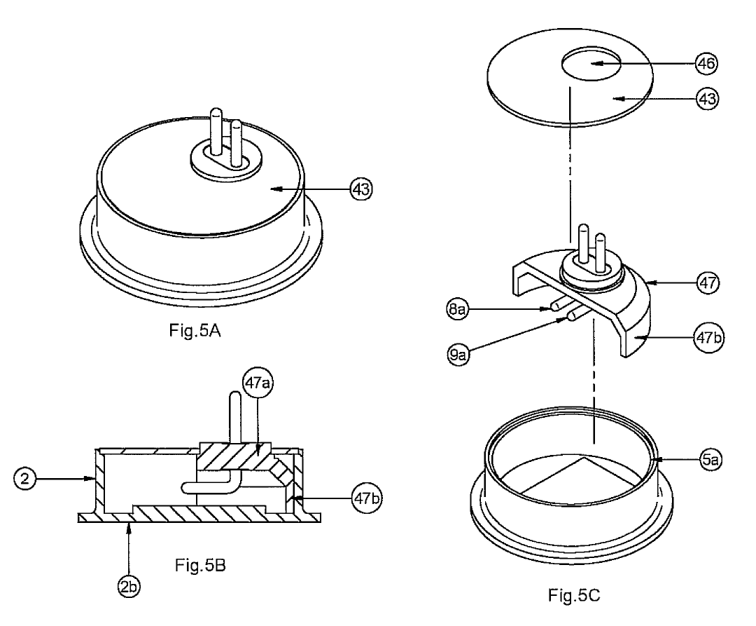

The final embodiment shown in FIGS. 5A to 5C is similar to that of FIGS. 4A to 4C except that instead of legs, the carrier 47 is formed with a semi-circular skirt 47b, the first ends 8a, 9a of the pins 8, 9 extending in a direction away from the skirt 47b as shown in FIG. 4C so as to facilitate making of connections thereto. The bottom edge of the skirt 47b then seats on the base 2b of the body 2 and the cylindrical portion 47a of the carrier 47 projects beyond the top of the body so that a lid 43 can be located thereon with the cylindrical portion 47a locating in an opening 46 formed in the lid 43 so that the lid can be moved down to seat on the lip 5a and secured to the body as with the previous embodiments.

What is claimed is:

1. An apparatus for packaging a sensor device comprising:
a main body having an internal chamber with a base on which, in use, is mounted the sensor so as to couple the sensor to the strain field in an article to which the packaging is attached by means of said base; and
a lid which is separately foed from and is formed of a material having different proportions to the material of said base, the lid being sealable to the main body in order to seal close said internal chamber, the lid including contact pins which extend therethrough from one side to the other, a first end of each said pins extending into said chamber when the lid is positioned on the body for connection to said sensor and a second end of each said pin extending away from the package when the lid is positioned on the body for connection to a rotary coupler.

2. The apparatus according to claim 1, wherein the packaging further includes:
a contact plate located within the internal chamber having a pair of connected contact pads for each pin in the lid, one of each said pair of connected contact pads being electrically coupled, in use, by connecting means to a contact pad on the sensor and the other of each of said pair of connected contact pads being electrically coupled, in use, by connecting means to the first end of one of said pins.

3. The apparatus according to claim 1, wherein each pin is shaped so that the second end extends perpendicularly to the plane of the lid and the pin is bent through 90 degrees after passing through the lid so that the first end extends parallel to the plane of the lid.

4. The apparatus according to claim 1, wherein the pins are mounted in a pin carrier which is separately formed from the lid and is engageable in an opening formed therein.

5. The apparatus according to claim 4, wherein the carrier is formed with a radially extending flange on one end which extends to a diameter larger than the opening formed in the lid, the remainder of the carrier being sized so as to be able to fit through the opening and the flange then forming a seat against the surface of the lid.

6. The apparatus according to claim 4, wherein the opening is a circular opening and the carrier is pushed through the lid from one side.

7. The apparatus according to claim 4, wherein the opening extends to a side of the lid so that the carrier may be inserted into the opening from the side, the lid further including a locking plate which has an opening formed therein which is engageable over the carrier so as to retain the carrier in the lid.

8. The apparatus according to claim 7, wherein the lid has a recess in it upper surface into which the locking plate engages.

9. The apparatus according to claim 1, wherein the contact means which connects to each pin is formed by a first generally flat part which, in use, connects to the first end of the associated pin and a second curved part which, in particular, is curved into a loop.

10. The apparatus according to claim 4, wherein the pin carrier is formed with legs which, when the carrier is secured to the lid and the lid is fastened to the main body, extend towards the base of the chamber and engage thereagainst to support the pins in position.

11. The apparatus according to claim 4, wherein the pin carrier is formed with a downwardly extending skirt which engages with the base of the chamber to support the pins in place relative to the lid.

12. A method of packaging a sensor comprising the steps of:
providing an apparatus for packaging a sensor device comprising a main body having an internal chamber with a base on which, in use, is mounted the sensor so as to couple the sensor to the strain field in an article to which the packaging is attached by means of said base; and a lid which is separately formed from and is formed of a material having different proportions to the material of said base, the lid being sealable to the main body in order to seal close said internal chamber, the lid including contact pins which extend therethrough from one side to the other, a first end of each said pins extending into said chamber when the lid is positioned on the body for connection to signal contacts of said sensor and a second end of each said pin for connection to a rotary coupler;
mounting the sensor to the base of the main body;
connecting signal contacts on the sensor to respective contact pins; and
positioning the lid on the main body so as to close the chamber with the pins protruding from the top of the lid and securing the lid to the main body.

13. The method according to claim 12, wherein the apparatus includes a contact plate, the method comprising the further steps of:
securing the contact plate to the base of the main body, completing connections between the contact plate and the sensor;
completing connections between the contact plate and the pins; and
closing the main body with the lid.

14. A method of packaging a sensor comprising the steps of:
providing an apparatus for packaging a sensor device comprising a main body having an internal chamber with a base on which, in use, is mounted the sensor so as to couple the sensor to the strain field in an article to which the packaging is attached by means of said base, and a lid which is separately formed from and is formed of a material having different proportions to the material of said base, the lid being sealable to the main body in order to seal close said internal chamber, and contact pins which are mounted in a pin carrier which is separately formed from the lid and is engageable in an opening formed therein;
positioning over the body a carrier plate having an opening therein for supporting the pin carrier, the carrier plate having a V-shaped recess is a side thereof which extends to said opening, sitting the pin carrier in the opening in the carrier plate with the first end of each pin extending underneath the V-shaped recess so as to be exposed by said recess;
making the connections between the first end of each pin and the signal contacts on the sensor;
positioning the lid on the carrier plate with the pin carrier engaging in the opening formed in the lid, securing the lid to the pin carrier;
removing the carrier plate from beneath the lid and pin carrier by withdrawing the carrier plate sideways so that the pin carrier passes along the V-shaped recess; and
securing the lid to the body.

15. The method according to claim 14, wherein the lid is hermetically sealed to the pin carrier and also to the body, preferably by laser welding.
